(19) United States
(12) Patent Application Publication
(10) Pub. No.: US 2011/0280634 A1
(43) Pub. Date: Nov. 17, 2011

(54) FIXING DEVICE AND IMAGE FORMING APPARATUS

(75) Inventors: Osamu YOSHIMURA, Tokyo (JP); Shougo FUKAI, Tokyo (JP)

(73) Assignee: KONICA MINOLTA BUSINESS TECHNOLOGIES, INC., Tokyo (JP)

(21) Appl. No.: 13/105,031

(22) Filed: May 11, 2011

(30) Foreign Application Priority Data
May 14, 2010 (JP) 2010-111844

(51) Int. Cl. G03G 15/20

(52) U.S. Cl. 399/323; 399/328; 399/329

(57) ABSTRACT

A fixing device includes a heating member to heat a sheet on which a toner image is supported; a pressing member to contact with the heating member so as to form a nip portion; a temperature detecting sensor to detect a temperature of the heating member without contacting with a surface of the heating member; and an air separating section to separate the sheet from the heating member by blowing air from a outlet to the sheet conveyed out from the nip portion, wherein the heating member is arranged to interrupt a straight line which connects the outlet and the temperature detecting sensor.

### CROSS REFERENCE TO RELATED APPLICATION

This application is based on Japanese Patent Application No. 2010-111844 filed on May 14, 2010, in Japanese Patent Office, the entire content of which is hereby incorporated by reference.

### BACKGROUND OF THE INVENTION

1. Field of the Invention

The present invention relates to a fixing device and an image forming apparatus.

2. Description of Related Art

Image forming apparatus employing electrophotographying systems, such as copying machines, printers, facsimiles, and combined machines provided with the functions of the above machines, are well known. In the image forming apparatus, a latent image formed on a photoreceptor is visualized with toner, and the visualized toner image is transferred onto a sheet and fixed on the sheet so that an image is formed on the sheet.

As a fixing device to fix a toner image onto a sheet, there is a roller type fixing device that forms a nip portion with a fixing roller, in which a heat source such as a halogen heater is incorporated, and a pressing roller which contact with the fixing roller, and the roller type fixing device conveys a sheet while pinching the sheet with the nip portion and heats and applies a pressure to the sheet.

Further, as another type fixing device, there is a belt type fixing device. In the belt type fixing device, an endless fixing belt is stretched by a fixing roller, in which a heat source such as a halogen heater is incorporated, and a pressing roller. This fixing device pinches the endless fixing belt between the fixing roller and the pressing roller so as to form a nip portion, and conveys a sheet while pinching the sheet with the nip portion and heats and applies a pressure onto the sheet.

In these fixing devices, toner on a sheet melts by being heated when the sheet passes through the nip portion. Therefore, there is a possibility that the sheet is wound around the surface of the fixing roller or the fixing belt by the adhesive force of the melted toner and is not separated so that a sheet jam is caused. Particularly, in the case where a thin sheet with a small basis weight and a coated sheet used for printing is employed as a sheet, such a sheet tends to wind around the surface of the fixing roller.

In order to prevent the winding of a sheet in the fixing device, a technique relating to an air separating mechanism is proposed to separate a sheet from a fixing roller or a fixing belt by blowing air from a outlet to a sheet conveyed from a nip portion (for example, refer to Patent Document 1). According to the air separating mechanism, since a sheet can be separated without bringing a separating member such as a separating claw in contact with the surface of a fixing roller, there is no fear to damage the surface of the fixing roller.

Further, in order to conduct a fixing action appropriately in such a fixing device, it is required to maintain a temperature at a fixing roller or a fixing belt appropriately. For this purpose, a temperature detecting sensor to detect a temperature at a fixing roller is arranged, and the temperature at the fixing roller is controlled. As the temperature detecting sensor, there are a contact type temperature detecting sensor that is brought in contact with the surface of a fixing roller and a non-contact type temperature detecting sensor that is not brought in contact with the surface of a fixing roller. In the contact type temperature detecting sensor, a trace remains so as to indicate the contact portion of the sensor on the surface of the fixing roller, and streaks take place due to difference in gloss at the remained trace, which results in lowering image quality.

Patent Document 1: Japanese Unexamined Patent Publication No. 2008-3277 Official Report

Patent Document 2: Japanese Unexamined Patent Publication No. 2009-93085 official report

The non-contact type temperature detecting sensor to detect a temperature at a fixing roller or a fixing belt has a large dependency for the surrounding environment. Accordingly, this type temperature detecting sensor is used on the condition that the inside of the fixing device is sealed from the outside. However, as mentioned above, if an air separating mechanism is employed in the fixing device in order to prevent the winding of a sheet, an air current is caused in the sealed inside of the fixing device by air blown from the air separating mechanism. As a result, the air current influences the operation of the non-contact type temperature detecting sensor, so that there is a possibility that a temperature at a fixing roller is erroneously detected.

### SUMMARY

Then, an object of the present invention is to provide a fixing device and an image forming apparatus which can execute a temperature control appropriately by suppressing erroneous detection in the non-contact type temperature detecting sensor.

To achieve the abovementioned object, a fixing device reflecting one aspect of the present invention, comprises:

a heating member to heat a sheet on which a toner image is supported;

a pressing member to contact with the heating member so as to form a nip portion;

a temperature detecting sensor to detect a temperature of the heating member on a non-contact condition for a surface of the heating member; and

an air separating section to separate the sheet from the heating member by blowing air from a outlet to the sheet conveyed out from the nip portion;

wherein the heating member is arranged to interrupt a straight line which connects the outlet and the temperature detecting sensor.

### BRIEF DESCRIPTION OF DRAWINGS

FIG. 1 is an entire structural view of an image forming apparatus relating to an embodiment of the present invention.

FIG. 2 is an enlarged cross sectional view of a fixing device relating to an embodiment of the present invention.

FIG. 3 is a perspective view showing only a heating roller and a fixing roller.

FIG. 4 is an enlarged cross sectional view showing a modified example of the fixing device.

FIG. 5 is an enlarged cross sectional view showing a roller type fixing device.

FIG. 6 is a perspective view of a heating roller.

### DETAILED DESCRIPTION OF THE PREFERRED EMBODIMENT

### [Outline of an Image Forming Apparatus]

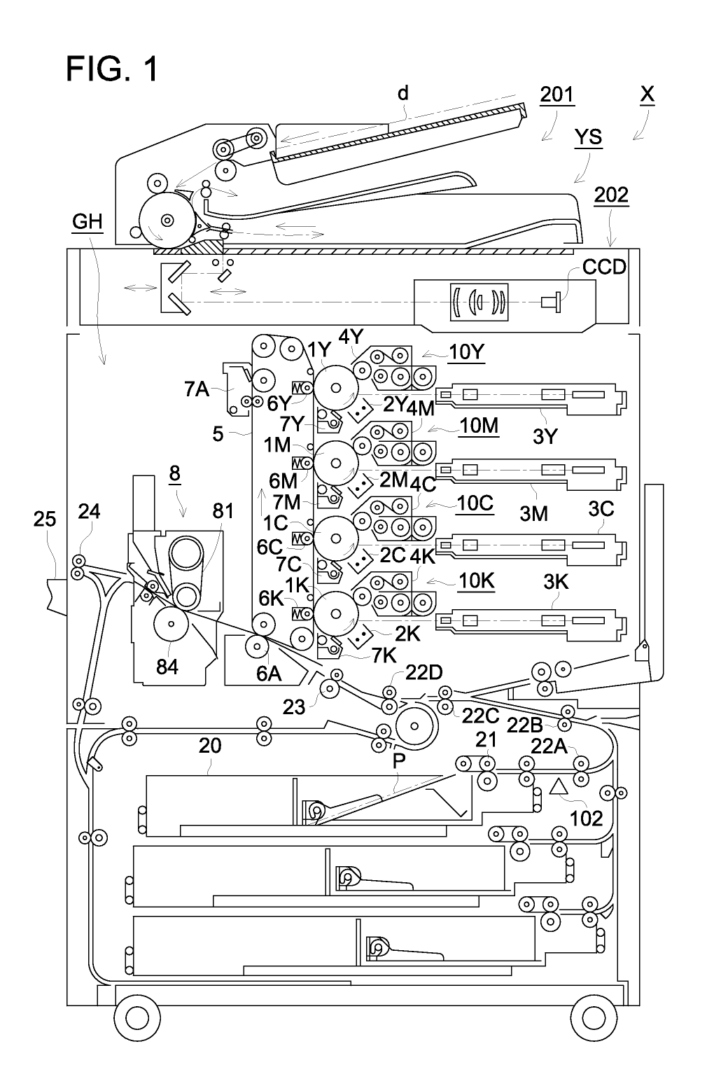

FIG. 1 is an entire structural view of an image forming apparatus X relating to an embodiment of the present invention.

The image forming apparatus X is constituted with an image forming apparatus main body GH and an image reading apparatus YS. The image forming apparatus main body GH includes a plurality of image forming sections 10Y, 10M, 10C, and 10K, a belt-shaped intermediate transfer belt 5, a sheet conveying section, and a fixing device 8.

On the upper portion of the image forming apparatus main body GH, the image reading apparatus YS constituted with an auto document feeding unit 201 and a document image scanning exposing unit 202 is arranged. A document d placed on a document table of the auto document feeding unit 201 is conveyed by a conveying section, and images on the one side or both sides of the document d are subjected to scanning exposure by an optical system of the document image scanning exposing unit 202 and are read into a line image sensor CCD.

Signals formed via photo-electric conversion by the line image sensor CCD are subjected to analog processing, A/D conversion, shading correction, image compression processing and the like in an image processing section, and then the resultant signals are transmitted to exposing sections 3Y, 3M, 3C, and 3K.

An image forming section 10Y to form an image with a yellow color (Y) includes a charging section 2Y, an exposing section 3Y, a developing section 4Y, and a cleaning section 7Y around a photoreceptor drum 1Y. Image forming sections 10M, 10C, and 10K have the almost same structure as that of the image forming section 10Y. The developing sections 4Y, 4M, 4C, and 4K include therein respectively a two component developer composed of toner being small size particles of yellow (Y), magenta (M), cyan (C), and black (K) and carrier. The toner is composed of pigment or dye used as a colorant, wax that assists the toner so as to be separated from the fixing belt after the fixing, and a binder resin to hold these substances.

Respective color images formed by the image forming sections 10Y, 10M, 10C, and 10K are transferred one after another by transfer sections 6Y, 6M, 6C, and 6K onto the intermediate transfer belt 5 that is supported to be rotatable. With this, a color toner image is formed on the intermediate transfer belt 5. A sheet P accommodated in a sheet feed cassette 20 is fed out from the sheet feed cassette 20 and conveyed to the transfer section 6A via sheet feeding rollers 22A, 22B, 22C, and 22D, and a registration roller 23, and then the color toner image formed on the intermediate transfer belt 5 is transferred onto the sheet P. The sheet P on which the color toner image has been transferred is heated and applied with pressure in the fixing device 8, so that the color toner image is fixed onto the sheet P. Thereafter, the sheet P is pinched and held by a sheet delivery roller 24 and placed on a sheet delivery tray 25.

After the color toner image has been transferred onto the sheet P by the transfer section 6A, toner remaining on the intermediate transfer belt from which the sheet P has been separated is removed by the cleaning section 7A.

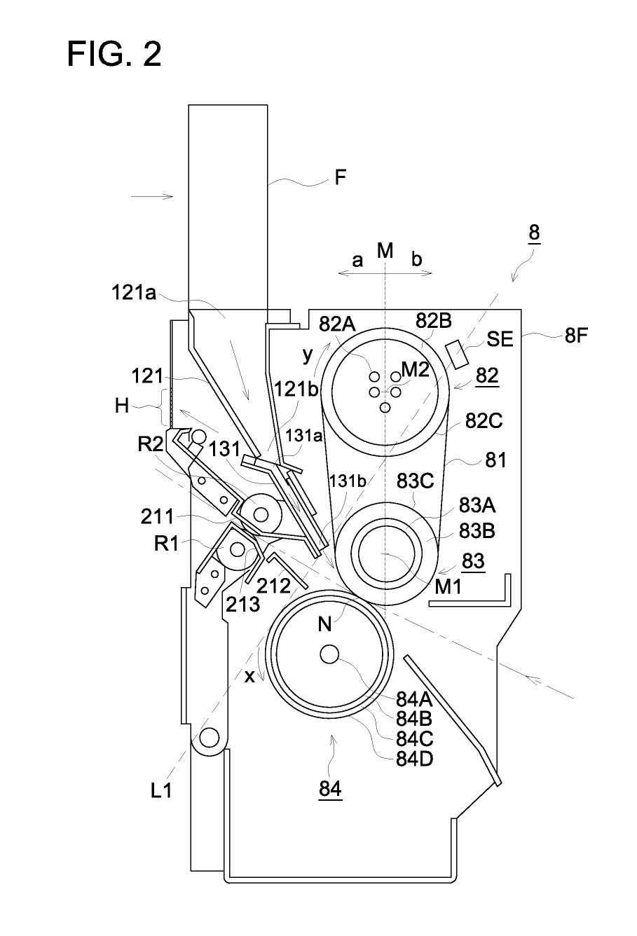

The fixing device shown in FIG. 2 is the fixing device in the first embodiment of the present invention. Here, the fixing device 8 shown in FIG. 2 employs a fixing belt 81 which is a belt-shaped heating member.

The fixing device 8 includes a fixing frame 8F, the fixing belt 81, a heating roller 82, a fixing roller 83, a pressing roller 84, a temperature detecting sensor SE, and an air separating section which is mentioned later. The fixing frame 8F is structured with a plurality of frame members, and forms an outer frame of the fixing device 8. Each of members constituting the fixing device 8 is supported directly or indirectly by the fixing frame 8F. The fixing frame 8F is supported to be able to shift by a guide mechanism such as slide rails, so that the fixing device 8 can be drawn to the outside of the image forming apparatus X in the front side direction (the front side direction on the sheet surface of FIG. 1 and FIG. 2).

The fixing belt 81 is an endless belt and is stretched bythe heating roller 82 and the fixing roller 83. For example, PI (polyimide) with a thickness of 70 μm is employed as the substrate of the fixing belt 81. The outer surface of this substrate is covered with a heat-resistant silicone rubber (hardness: JIS-A30°) with a thickness of 200 μm as an elastic layer. Further, the surface of this elastic layer is coated with PFA (perfluoro alkoxy) being a heat-resistant resin with a thickness of 30 μm.

The heating roller 82 incorporates therein a halogen heater 82 A to heat the fixing belt 81. Further, this heating roller 82 includes a core metal 82B and a resin layer 82C. The core metal 82B is composed of, for example, a cylinder made of aluminum with a thickness of 4 mm. The outer surface of the core metal 82B is covered with a resin layer 82C which is coated with PTFE (poly tetrafluoroethylene) with a thickness of 30 μm. In order to cope with different sheet widths, the halogen heater 82A include, for example, two heater elements with 1200 W, two heater elements with 750 W and one element with 500 W. These heater elements are arranged to form different heat generation distributions in the axial direction corresponding to different sheet width of sheets.

In order to form a nip portion N between the fixing belt 81 and the pressing roller 84, the fixing roller 83 is arranged opposite to the pressing roller. That is, in the first embodiment, the fixing roller 83 corresponds to the first roller in the present invention, and the pressing roller 84 corresponds to a pressing member in the present invention.

The fixing roller 83 includes a core metal 83A, an elastic layer 83B, and a resin layer 83C. The core metal 83A is composed of a solid member made of, for example, metals such as iron. The core metal 83A is covered with a heat-resistant silicone rubber with a thickness of 20 mm as an elastic layer 83B. Further, the elastic layer 83B is covered with a resin layer 83 C coated with PTFE which is a low friction and heat resistant resin with a thickness of 30 μm.

In the vicinity of the heating roller 82, a temperature detecting sensor SE to detect the temperature of the fixing belt 81 on the non-contact condition to the fixing belt 81 is arranged. More concretely, the temperature detecting sensor SE is arranged at the upstream side than the nip portion N in terms of the conveying direction of a sheet. On the basis of the detection result of the temperature detecting sensor SE, the halogen heater 82A is controlled to be ON or OFF, so that the temperature of the fixing belt 81 is maintained at a proper temperature for fixing.

The pressing roller 84 that contact with the fixing belt 81 incorporates therein a halogen heater 84A as a heating means for shortening a temperature raising time right after a power source for the image forming apparatus X has been turned on. Further, the pressing roller 84 includes a core metal 84B, an elastic layer 84C, and a resin layer 84D. The core metal 84B is composed of, for example, a cylinder made of aluminum with a thickness of 4 mm. The outer surface of the core metal 84B is covered with a heat resistant silicone rubber (hardness: JIS-A30°) with a thickness of 1 mm as the elastic layer 84C. Further, the elastic layer 84C is covered with the resin layer 84D which is a PFA tube with a thickness of 30 μm. The pressing roller 84 has an outer diameter of 90 mm. Further, the pressing roller 84 can press the fixing roller 83 via the fixing belt 81 by an pressing mechanism.

In the abovementioned structure, when a toner image is fixed onto a sheet P, the fixing belt 81 is heated by the halogen heater 82A via the heating roller 82, and the pressing roller 84 is also heated by the halogen heater 84A.

Then, when the pressing roller 84 is rotated in an anticlockwise rotating direction (in FIG. 2, in the X-direction) by a driving mechanism, the fixing belt 81, the heating roller 82, and the fixing roller 83 are rotated in a clockwise rotating direction (in FIG. 2, in the y-direction).

The sheet P is conveyed to the fixing device, and, when this sheet P passes through the nip portion between the fixing belt 81 and the pressing roller 84, the sheet P is heated and applied with a pressure. As a result, the toner is fixed onto the sheet P.

### [Outline of an Air Separating Mechanism]

In the fixing device, since there is fear that a sheet P on which a toner image has been fixed adheres on and winds around the fixing belt 81 after the sheet has been conveyed out from the nip portion N, there is a need to separate surely the fixed sheet P from the fixing belt 81. The fixing device 8 in the embodiment of the present invention includes an air separating section as an air separating mechanism to separate the sheet P from the fixing belt 81 by blowing air to the sheet P conveyed out from the nip portion N. More concretely, the air separating section is arranged such that a discharging port of the air separating section is positioned at the downstream side than the nip portion N in terms of the conveying direction. The air separating section is constituted with, for example, a fan F, a first duct 121, and a second duet 131.

As shown in FIG. 2, an opening portion 121a of the first duct 121 is connected to the fan F directly or via a communication duct. Further, another opening portion 121b of the first duct 121 is connected to an opening portion 131a of the second duct 131. The opening portion 121b and the opening portion 131a are made in a sealed structure by packing such as rubber. With this structure, air sent from the fan F is prevented from leaking from the first duct 121 and the second duct 131 to the outside.

The outlet 131b which is an another opening portion of the second duct 131 is arranged in the vicinity of the nip portion N. The air sent from the fan F flows inside the first duct 121 and the second duct 131 and is discharged from the outlet 131b. With this, air proceeds in between a sheet and the fixing belt 81 and the sheet is separated from the fixing belt 81. Accordingly, it becomes possible to prevent the sheet from winding around the fixing belt 81. Further, since a sheet is separated from the fixing belt 81 by the air separating section constituted by the fan F, the first duct 121, and the second duct 131, the sheet can be separated without bringing a member such as a separating claw in contact with the surface of the fixing belt 81. Accordingly, there is no fear to damage the surface of the fixing belt 81.

The sheet separated from the fixing belt 81 by the air separating section is guided by an upper guide 211 and low guides 212 and 213, pinched and held by conveying rollers R1 and R2, and conveyed toward a sheet discharging roller 24 (refer to FIG. 1) positioned at a downstream side in the conveying direction.

### [Arrangement of the Outlet of the Air Separating Section and the Temperature Detecting Sensor]

The temperature detecting sensor SE to detect the temperature of the fixing belt 81 is a non-contact type sensor so that its measurement result tends to change greatly depending on ambient temperature. Accordingly, if the air blown from the outlet 131b of the second duct 131 flows into the periphery of the temperature detecting sensor SE, the surrounding environment of the temperature detecting sensor SE fluctuates, which results in that it becomes difficult to detect accurately the temperature of the fixing belt 81. Then, in the fixing device 8 in the embodiment of the present invention, ingenuity has been made in the arrangement of the outlet 131b and the temperature detecting sensor SE.

As the first ingenuity, as shown in FIG. 2, the fixing belt 81 is arranged to interrupt a straight line L1 connecting the outlet 131b and the temperature detecting sensor SE. In other words, the outlet 131b and the temperature detecting sensor SE are arranged such that a straight line L1 which connects the outlet 131b and the temperature detecting sensor SE is interrupted by the fixing belt 81.

When the outlet 131b and the temperature detecting sensor SE are arranged in this way, since the fixing belt 81, the heating roller 82, and the fixing roller 83 becomes a wall, it becomes difficult for air blown from the outlet 131b to flow around the periphery of the temperature detecting sensor SE, whereby the fluctuation of the surrounding environment of the temperature detecting sensor SE can be suppressed. As a result, an erroneous detection in the temperature detecting sensor SE can be suppressed so as to control the temperature properly.

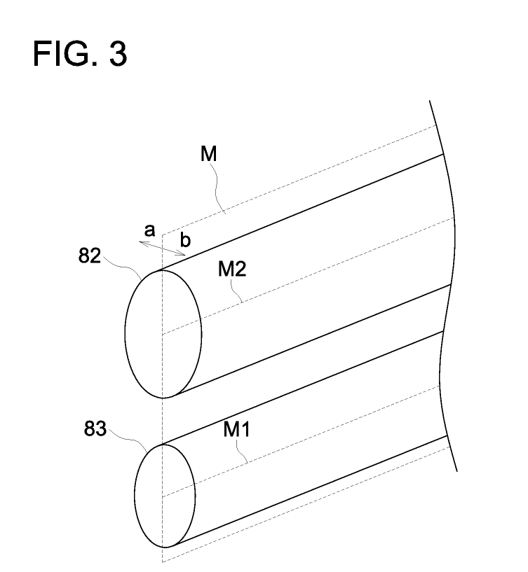

FIG. 3 is a perspective view showing only the heating roller 82 and the fixing roller 83. In FIG. 2 and FIG. 3, M1 represents a central axis of the fixing roller 83, and M2 represents a central axis of the heating roller 82. Here, in the case where the rollers stretching the fixing belt 81 are only two of the heating roller 82 and the fixing roller 83, the heating roller 82 corresponds to the second roller of the present invention.

The sign M in FIG. 2 and FIG. 3 is a virtual plane which includes the central axis M2 of the heating roller 82 being the second roller and the central axis M1 of the fixing roller 83.

As the second ingenuity, the outlet 131b is arranged at an arrow mark “a” side of this virtual plane M, and the temperature detecting sensor SE is arranged at an arrow mark “b” side of this virtual plane M. Namely, the temperature detecting sensor SE is arranged at the opposite side of the outlet 131b in terms of the virtual plane M or across the virtual plane M.

When the temperature detecting sensor SE is arranged at the opposite side of the outlet 131b in terms of the virtual plane M, air blown from the outlet 131b is interrupted by the wall of the fixing belt 81, the heating roller 82, and the fixing roller 83. With this, it becomes difficult for air to flow around the periphery of the temperature detecting sensor SE, whereby the fluctuation of the surrounding environment of the temperature detecting sensor SE can be suppressed. As a result, an erroneous detection in the temperature detecting sensor SE can be suppressed so as to control the temperature properly.

As the third ingenuity, as shown in FIG. 2, an exhaust port H to exhaust air is arranged at the arrow mark “a” side of the virtual plane M (which is the side where the outlet 131b is arranged and the opposite side of the arrow mark “b” side where the temperature detecting sensor SE is arranged). Since air blown from the outlet 131b can be positively exhausted outside the fixing device 8 from the exhaust port H, it becomes more difficult for air to flow into the periphery of the temperature detecting sensor SE, whereby the fluctuation of the surrounding environment of the temperature detecting sensor SE can be suppressed appreciably.

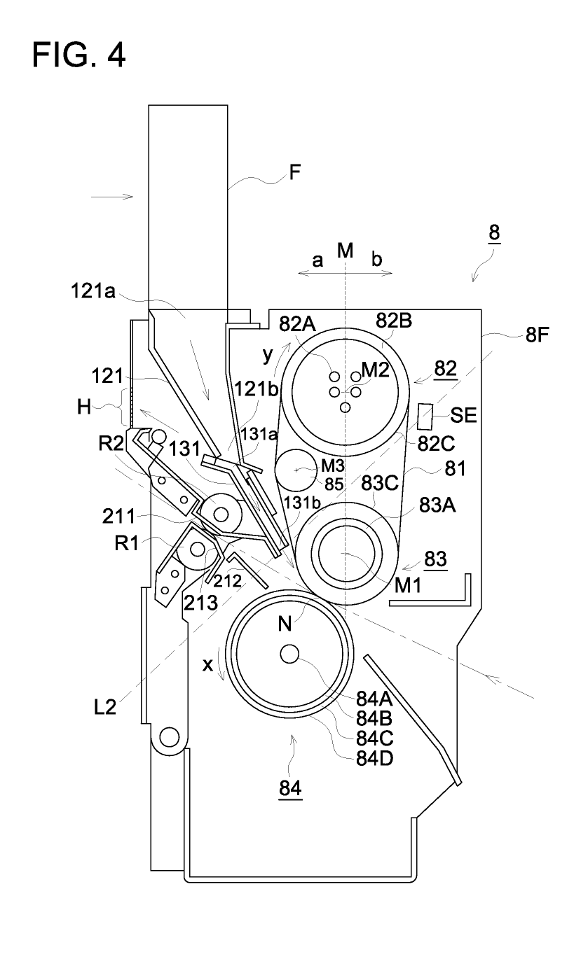

The fixing device 8 shown in FIG. 4 is a fixing device in the second embodiment of the present invention. This fixing device 8 is a modified example of the fixing device shown in FIG. 3, and the fixing belt 81 is stretched by a roller group composed of three rollers of the heating roller 82, the fixing roller 83, and a stretching roller 85.

In the case of the fixing device 8 of this type, each of the abovementioned first, second and third ingenuity is applied. Namely, as the first ingenuity, as shown in FIG. 4, the outlet 131b and the temperature detecting sensor SE are arranged such that a straight line L2 which connects the outlet 131b and the temperature detecting sensor SE is interrupted by the fixing belt 81.

Further, when the fixing roller 83 closest to the outlet 131b among the abovementioned roller group is made as a standard, a roller having a central axis having a farthest straight line distance from the central axis M1 of the fixing roller 83 being the standard is made as the second roller. For example, in the case shown in FIG. 4, since the straight line distance from the central axis M1 to the central axis M2 of the heating roller 82 is longer than the straight line distance from the central axis M1 to the central axis M3 of the stretching roller 85, the heating roller 82 corresponds to the second roller in the present invention.

As the second ingenuity, in terms of a virtual plane M which includes the central axis M2 of the heating roller 82 being the second roller and the central axis M1 of the fixing roller 83 being the first roller, the temperature detecting sensor SE is arranged at the opposite side of the outlet 131b.

As the third ingenuity, an exhaust port H to exhaust air is arranged at the arrow mark “a” side of the virtual plane M (which is the side where the outlet 131b is arranged and the opposite side of the arrow mark “b” side where the temperature detecting sensor SE is arranged).

In this way, in the fixing device 8 shown in FIG. 4, since each of the first, second, and third ingenuity is also adopted, the same effect as that in the fixing device 8 shown in FIG. 2 can be attained.

Further, as shown in FIG. 4, in the case where the fixing belt 81 is stretched by three or more rollers, a roller having a central axis having a farthest straight line distance from the central axis M1 of the fixing roller 83 is made as the second roller, and in terms of a virtual plane M which includes the central axis of the second roller and the central axis of the first roller, the temperature detecting sensor SE is arranged at the opposite side of the outlet 131b. With this arrangement, it is avoided to arrange the temperature detecting sensor SE in the vicinity of the outlet 131b, whereby the effect to suppress the fluctuation of the surrounding environment of the temperature detecting sensor SE due to air blown from the outlet 131b can be enhanced.

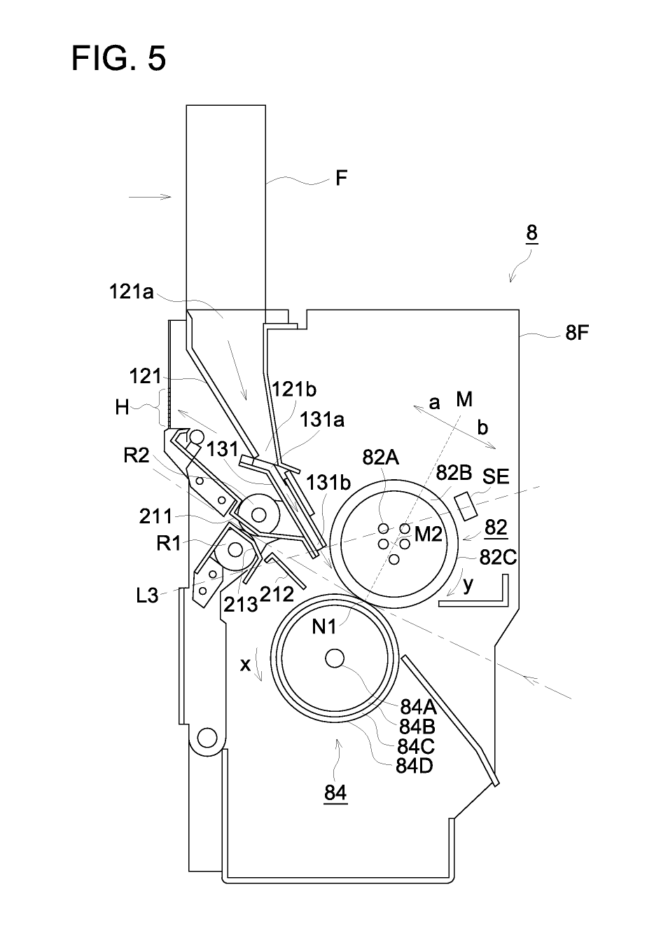

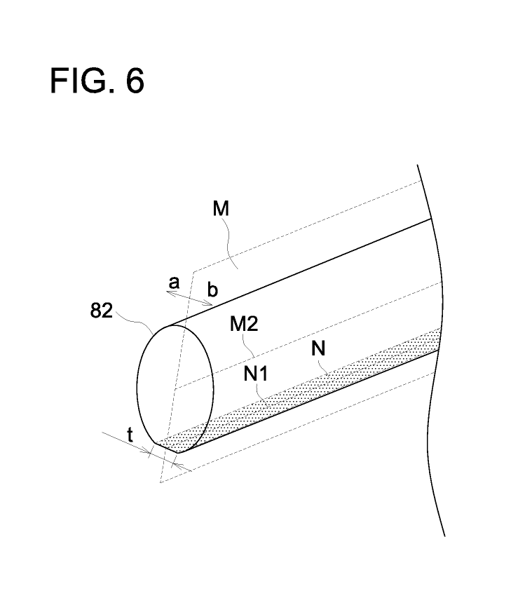

The fixing device 8 shown in FIG. 5 and FIG. 6 is a fixing device in the third embodiment of the present invention. In the fixing device 8 shown in FIG. 2 through FIG. 4, the fixing belt 81 which is a belt-shaped heating member is employed. On the other hand, in the fixing device 8 shown in FIG. 5 and FIG. 6, a roller-shaped heating member is employed as another modified example. FIG. 5 is an enlarged cross sectional view showing a roller-type fixing device, and FIG. 6 is a perspective view of the heating roller 82. Here, in the embodiment shown in FIG. 2 through FIG. 4, the fixing belt 81 corresponds to the heating member of the present invention. However, in the embodiment shown in FIG. 5 and FIG. 6, the heating roller 82 corresponds to the heating member of the present invention.

A sign N1 represents a central line of the nip portion which passes the center of the width “t” of the nip portion N in the lengthwise direction of the heating roller 82, and a sign M represents a virtual plane which includes the central axis M2 of the heating roller and the central line N1 of the nip section N.

In the fixing device 8 shown in FIG. 5 and FIG. 6, each of the abovementioned first, second and third ingenuity is applied. Concretely, as the first ingenuity, as shown in FIG. 5, the outlet 131b and the temperature detecting sensor SE are arranged such that a straight line L3 which connects the outlet 131b and the temperature detecting sensor SE is interrupted by the heating roller 82.

As the second ingenuity, the outlet 131b is arranged at the arrow mark “a” side of the virtual plane M, and the temperature detecting sensor SE is arranged at the arrow mark “b” side of the virtual plane M. That is, the temperature detecting sensor SE is arranged at the opposite side of the outlet 131b in terms of the virtual plane M.

As the third ingenuity, an exhaust port H to exhaust air is arranged at the arrow mark “a” side of the virtual plane M (which is the side where the outlet 131b is arranged and the opposite side of the arrow mark “b” side where the temperature detecting sensor SE is arranged).

In this way, in the roller type fixing device shown in FIG. 5, each of the first, second, and third ingenuity is also adopted. Accordingly, since the heating roller 82 becomes a wall, it becomes difficult for air blown from the outlet 131b to flow around the periphery of the temperature detecting sensor SE, whereby the fluctuation of the surrounding environment of the temperature detecting sensor SE can be suppressed. As a result, an erroneous detection in the temperature detecting sensor SE can be suppressed, thereby proper temperature control can be achieved.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A fixing device comprising:
a heating member to heat a sheet on which a toner image is supported;
a pressing member to contact with the heating member so as to form a nip portion;
a temperature detecting sensor to detect a temperature of the heating member without contacting with a surface of the heating member; and
an air separating section to separate the sheet from the heating member by blowing air from a outlet to the sheet conveyed out from the nip portion;
wherein the heating member is arranged to interrupt a straight line which connects the outlet and the temperature detecting sensor.

2. The fixing device described in claim 1, wherein the heating member is shaped in a belt, the heating member is stretched by a roller group which includes a first roller arranged at a position opposite to the pressing roller so as to form the nip portion and a second roller having a central axis located with a farthest distance from a central axis of the first roller, and the temperature detecting sensor is arranged at an opposite side of the outlet across a virtual plane which includes the central axis of the first roller and the central axis of the second roller.

3. The fixing device described in claim 2, wherein an exhaust port to exhaust air blown from the outlet to the outside of the fixing device is arranged at an opposite side of the temperature detecting sensor across the virtual plane.

4. The fixing device described in claim 1, wherein the heating member is shaped in a roller, and wherein the temperature detecting sensor is arranged at an opposite side of the outlet across a virtual plane which includes a central axis of the heating member and a central line of the nip portion in a lengthwise direction of the heating member.

5. The fixing device described in claim 4, wherein an exhaust port to exhaust air blown from the outlet to the outside of the fixing device is arranged at an opposite side of the temperature detecting sensor across the virtual plane.

6. An image forming apparatus having a fixing device, the fixing device comprising:
a heating member to heat the sheet on which a toner image is supported;
a pressing member to contact with the heating member so as to form a nip portion;
a temperature detecting sensor to detect a temperature of the heating member without contacting with a surface of the heating member; and
an air separating section to separate the sheet from the heating member by blowing air from a outlet to the sheet conveyed out from the nip portion;
wherein the heating member is arranged to interrupt a straight line which connects the outlet and the temperature detecting sensor.

7. The image forming apparatus described in claim 6, wherein the heating member is shaped in a belt, the heating member is stretched by a roller group which includes a first roller arranged at a position opposite to the pressing roller so as to form the nip portion and a second miler having a central axis located with a farthest distance from a central axis of the first roller, and the temperature detecting sensor is arranged at an opposite side of the outlet across a virtual plane which includes the central axis of the first roller and the central axis of the second roller.

8. The image forming apparatus described in claim 7, wherein an exhaust port to exhaust air blown from the outlet to the outside of the fixing device is arranged at an opposite side of the temperature detecting sensor across the virtual plane.

9. The image forming apparatus described in claim 6, wherein the heating member is shaped in a roller, and wherein the temperature detecting sensor is arranged at an opposite side of the outlet across a virtual plane which includes a central axis of the heating member and a central line of the nip portion in a lengthwise direction of the heating member.

10. The image forming apparatus described in claim 9, wherein an exhaust port to exhaust air blown from the outlet to the outside of the fixing device is arranged at an opposite side of the temperature detecting sensor across the virtual plane.

11. A fixing device comprising:
a heating member to heat a sheet on which a toner image is supported;
a pressing member to contact with the heating member so as to form a nip portion;
a temperature detecting sensor to detect a temperature of the heating member without contacting with a surface of the heating member; and
an air separating section to separate the sheet from the heating member by blowing air from a outlet to the sheet conveyed out from the nip portion;
wherein the outlet is located at a downstream side than the nip portion in a sheet conveying direction, the temperature detecting sensor is located at an upstream side than the nip portion in the sheet conveying direction, and the heating member prevents air blown from the outlet from reaching the temperature detecting sensor.

12. The fixing device described in claim 11, wherein the heating member is shaped in a belt, the heating member is stretched by a roller group which includes a first roller arranged at a position opposite to the pressing roller so as to form the nip portion and a second roller having a central axis located with a farthest distance from a central axis of the first roller, and the temperature detecting sensor is arranged at an opposite side of the outlet across a virtual plane which includes the central axis of the first roller and the central axis of the second roller.

13. The fixing device described in claim 12, wherein an exhaust port to exhaust air blown from the outlet to the outside of the fixing device is arranged at an opposite side of the temperature detecting sensor across the virtual plane.

14. The fixing device described in claim 11, wherein the heating member is shaped in a roller, and wherein the temperature detecting sensor is arranged at an opposite side of the outlet across a virtual plane which includes a central axis of the heating member and a central line of the nip portion in a lengthwise direction of the heating member.

15. The fixing device described in claim 14, wherein an exhaust port to exhaust air blown from the outlet to the outside of the fixing device is arranged at an opposite side of the temperature detecting sensor across the virtual plane.
